(19) United States
(12) Patent Application Publication
(10) Pub. No.: US 2023/0278453 A1
(43) Pub. Date: Sep. 7, 2023

(54) METHOD FOR CONTROLLING A CHARGING INFRASTRUCTURE

(71) Applicant: AUDI AG, Ingolstadt (DE)

(72) Inventors: Christina BÖHMER, Kasing (DE); Florian SCHWENSFEIER, Oberhausen an der Donau (DE)

(21) Appl. No.: 18/176,366

(22) Filed: Feb. 28, 2023

(30) Foreign Application Priority Data
Mar. 1, 2022 (DE) 102022104771.7

(51) Int. Cl. B60L 53/68; B60L 53/65; B60L 58/12

(52) U.S. Cl. CPC B60L 53/68; B60L 53/65; B60L 58/12; B60L 2240/62; B60L 2240/68; B60L 2240/72

(57) ABSTRACT

A method for controlling a charging infrastructure including spatially distributed electrical charging stations configured to be used by multiple vehicles of a fleet which are powered by drive batteries, the method comprising using a control system, wherein the control system encompasses a charging stations database, containing information about the availability of the electrical charging stations, a drive batteries database, containing information about states of charge of the drive batteries of the vehicles of the fleet, and a fleet navigation system, containing information about the spatial distribution of the vehicles of the fleet and information about respective traffic situations in which the vehicles of the fleet are involved, determining positions of vehicles of the fleet in a defined region and determining states of charge of drive batteries of the vehicles of the fleet in the defined region are, traffic situations in the defined region being taken into account, and depending on the availability of free charging stations and their respective positions in the defined region, depending on positions and states of charge of drive batteries of the vehicles of the fleet in the defined region, and depending on the respective traffic situations in the region, automatically determining, by the control system, for at least one vehicle in the defined region, a charging station to carry out a charging process for the drive battery of the at least one vehicle.

### BACKGROUND

### Technical Field

Embodiments of the invention relate to a method for controlling a charging infrastructure and a control system.

### Description of the Related Art

An electrical charging infrastructure should be suitably administered for a plurality of vehicles.

Electrical charging systems for vehicles are known from documents IN 201611014217 A, CN 108183514 A and CN 109398149 A.

Against this background, one problem was to suitably control an electrical charging infrastructure for multiple vehicles.

### BRIEF SUMMARY

In some embodiments a method is proposed and/or designed to control, i.e., usually to control, regulate, plan and/or administer or manage an electrical charging infrastructure, wherein this charging infrastructure comprises multiple spatially distributed electrical charging stations for vehicles of a fleet composed of multiple vehicles, wherein each vehicle of the fleet is powered by an electric machine, which is supplied by an electrical drive battery with electrical energy, wherein the charging infrastructure or its charging stations is or are used by these vehicles to charge their drive batteries. In the method, a control system is used, having as its components a charging stations database, a drive batteries database and a fleet navigation system. The charging stations database comprises or contains as parameters information about the availability, such as the occupancy, workload, and/or charging capacity, of the electrical charging stations. The drive batteries database comprises or contains as parameters information about states of charge of drive batteries of the vehicles of the fleet. The fleet navigation system comprises or contains as parameters information about the spatial distribution of the vehicles of the fleet as well as information about respective traffic situations in which the vehicles of the fleet are involved. In the method, positions of vehicles of the fleet are determined in a designated defined, definable, or yet to be defined region and states of charge of the drive batteries of the vehicles are determined in this region, while also determining traffic situations in this defined region. Moreover, all charging stations in this region are taken into account. Furthermore, depending on the availability of free charging stations and their respective positions in the defined region, depending on positions and states of charge of drive batteries of all vehicles of the fleet in the defined region, and depending on the respective traffic situations in the region, the control system automatically determines and/or selects for at least one vehicle of the fleet in the region a charging station to carry out an electrical charging process for the drive battery of the at least one vehicle and automatically proposes this to the at least one vehicle.

In one embodiment, positions of all other vehicles of the fleet which are located in the defined region around the position of the at least one vehicle are determined, and the at least one charging station is determined and/or selected while taking into account the traffic situation existing between the position of the at least one vehicle and the charging stations in the definable, yet to be defined, or defined region. Here in one embodiment the position of the at least one vehicle, in one embodiment the position of one or each vehicle, is used as the center of the definable, yet to be defined, or defined region, the region corresponding to a circle with a definable, yet to be defined, or defined radius about the center, which likewise moves upon movement of the at least one vehicle and thus its current position.

With the method and the control system it is possible to control, that is, to control, regulate, plan and/or administer or manage an electrical charging process for the drive battery of at least one vehicle and thus for each vehicle belonging to the fleet with a charging station, such as a charging point. Each drive battery of each vehicle generally has at least one drive battery module as its electrical energy accumulator.

In the method, the charging station intended for the at least one vehicle is automatically determined, taking into account the aforementioned parameters or information, i.e., the availability of electrical charging stations, the spatial distribution of the vehicles and thus also that of positions of vehicles, i.e., each position for each vehicle of the fleet, depending on the particular traffic situations, depending on the particular states of charge of the drive batteries, i.e., each state of charge of each drive battery, and the positions of the charging stations, also automatically taking into account and/or weighing against each other the mutual relationships and/or dependencies of certain of the above indicated parameters for all vehicles of the fleet. It is also possible to dynamically update the mentioned parameters.

Furthermore, the charging station proposed and/or determined for the at least one vehicle is reserved by the control system. In one embodiment, when selecting this charging station among the multiple charging stations consideration is also given to whether it is still reachable or can be reached by the at least one vehicle depending on the state of charge (SOC) of its drive battery and/or depending on its position, taking into account the length of the distance to be traveled by the at least one vehicle to this charging station and/or the time required for this, depending on traffic situations along the route.

Furthermore, the at least one vehicle and/or its driver is navigated with the fleet navigation system to the at least one charging station. For the navigating of the at least one vehicle, a navigation assistant arranged in the vehicle is used, which is designed or can be designated as the interface of the fleet navigation system with the at least one vehicle, usually each vehicle of the fleet having such a navigation assistant. During such a navigation, the at least one vehicle is either automatically steered and/or controlled by the fleet navigation system or manually steered and/or controlled by the driver on the basis of information provided to him by the navigation assistant.

In the method, current positions of vehicles of the fleet and current traffic situations are detected by the fleet navigation system. Moreover, future positions of vehicles of the fleet and future traffic situations are predicted by the fleet navigation system. Current states of charge of the drive batteries of the vehicles are ascertained by the drive batteries database, i.e., for each drive battery of each vehicle, and future states of charge of the drive batteries of the vehicles, i.e., for each drive battery of each vehicle, are predicted by the drive batteries database. Alternatively or additionally, the current availability, such as the current occupancy, current workload, and/or current charging capacity of the charging stations or of each charging station is ascertained by the charging stations database and a future availability, such as a future occupancy, future workload and/or future charging capacity of the charging stations or that of each charging station is predicted by the charging stations database.

It is possible in the method to take into account at least each current traffic situation and also predicted future traffic situations as the parameters, the future traffic situations being predicted by the fleet navigation system in dependence on movements of the vehicles of the fleet.

In another embodiment, it is possible to select and establish one energy saving mode among several energy saving modes is for the at least one vehicle. Furthermore, it is possible to also consider this energy saving mode, being usually the currently established one, as a parameter of the drive batteries database when carrying out the method for control of the charging infrastructure, which is especially possible when the at least one vehicle is driving to the charging station, while furthermore it is possible to update the energy saving mode in dependence on the route yet to be traveled and/or the state of charge of the drive battery, possibly also selecting a new energy saving mode, automatically for example, to replace the previously established energy saving mode.

It is possible for the control system to be self-learning, usually by making use of artificial intelligence. In this case, it is possible to take account of parameters used in the past, especially values of these parameters, which are registered, such as measured and/or predicted, as well as their mutual relationships, during a learning process of the control system, such as have resulted from previous runs of the method. It is also possible to use runs of the method for a fleet organized or designated as a training fleet.

In another embodiment, the probability of observing a deadline or a time for the charging process with the determined or proposed charging station by the at least one vehicle is taken into account by the fleet navigation system. It is possible for this probability to be considered with allowance for positions of all vehicles of the fleet and the particular current and/or future traffic situations.

Generally consideration is given only to charging stations and other vehicles of the fleet, besides the at least one vehicle, within the described defined region. Other charging stations and vehicles of the fleet outside this region are generally not taken into account. However, it is also possible, on the basis of a possible prediction of the traffic situations, to give consideration as well to other vehicles of the fleet which are at first still located outside the region and are approaching it, and which will be and/or might be located in the region in future.

In general, a traffic situation on at least one roadway, such as a road, in a region results from the number of vehicles on the at least one roadway and thus the density, such as the traffic density, of the vehicles on the at least one roadway and kinematic parameters of these vehicles. At least one kinematic parameter of a respective vehicle is its position or location, its speed, and/or its acceleration, generally being considered in dependence on the direction. These kinematic parameters of the vehicles of the fleet, including the at least one vehicle, which are designed and/or designated as fleet vehicles, are determined directly by the fleet navigation system. On this basis, it is possible to make statements about the traffic situation, the traffic situation being at least partly determined, since at first only the fleet vehicles are taken into account.

With the method, the particular traffic situation is also determined in dependence on all vehicles in the region, giving consideration to further fleet-independent vehicles, which are also designed and/or designated as third-party vehicles, and their usually direction-dependent kinematic parameters in the region. It is possible for the fleet navigation system to determine, through a traffic service to which it has access, and/or depending on cameras which are arranged on the fleet vehicles, the third-party vehicles and/or their kinematic parameters as well as a particular traffic situation. Taking into consideration the own vehicles and the third-party vehicles in the region, the fleet navigation system registers the current traffic situation and predicts a future traffic situation.

With the above described components of the control system and taking into account the mentioned parameters, it is possible in one embodiment of the method to automatically optimize the workload of the charging infrastructure.

Each vehicle of the fleet usually starts from its current position and drives to a destination, which is intended and/or selected for the vehicle, usually by its driver, the destinations of all of the vehicles being taken into consideration with the fleet navigation system. In one embodiment of the method, a further parameter taken into account is also the destination of the at least one vehicle. If the at least one vehicle en route to its destination is driving past a charging station and furthermore the state of charge of its drive battery is insufficient to reach the next charging station in the direction of its destination, the control system proposes to the at least one vehicle to head for the charging station which it is presently driving past or has driven past. Accordingly, taking into consideration the destination of the at least one vehicle, it is also possible that it will be proposed a charging station which lies on a detour, differing from the direct route of the at least one vehicle from its current position to its intended destination, if the state of charge of its drive battery is insufficient to reach the next charging station on the way to this destination.

It is possible for the control system to carry out the method to be provided by at least one entity, such as at least one manufacturer of vehicles of the fleet, for example multiple manufacturers, if the fleet encompasses vehicles from multiple manufacturers, and/or a service provider and/or an operator of the charging infrastructure.

In one embodiment of the method, the mentioned parameters or information about them are exchanged specifically and dynamically between participants of the method, i.e., the spatially distributed charging stations, the vehicles of the fleet, and the components of the control system. The planning of the workload of the charging infrastructure is monitored and thus controlled and/or regulated in consideration of the usually dynamically changing parameters.

In one embodiment of the method, it is possible to plan the workload of the charging stations of the charging infrastructure for all vehicles of the fleet and/or in consideration of all vehicles, i.e., depending on their positions and the states of charge of their drive batteries. When determining and/or selecting the charging station for the at least one vehicle, consideration is also given with the at least one component of the control system to charging processes currently performed for other vehicles of the fleet at respective charging stations and usually also a future workload of the charging stations for the other vehicles of the fleet, wherein each time a charging station is determined and/or selected and reserved for another vehicle of the fleet, analogously to the at least one vehicle.

The control system described herein is designed for control, including the administering or managing, of a charging infrastructure having spatially distributed electrical charging stations and used by multiple vehicles of a fleet. The control system encompasses a charging stations database, containing information about an availability, usually a current and optionally also a predicted, predictable, or yet to be predicted availability, as a parameter of the electrical charging stations, a drive batteries database, which contains usually current and optionally also predicted, predictable or yet to be predicted information on states of charge as a parameter of drive batteries of the vehicles of the fleet, and a fleet navigation system, which contains usually current and optionally also predicted, predictable or yet to be predicted information on the spatial distribution as a parameter of the vehicles of the fleet as well as information on respective traffic situations as a further parameter in which the vehicles of the fleet are involved. At least one component of the control system, usually at least the fleet navigation system, is adapted to determine usually current and predictable or yet to be predicted positions of vehicles of the fleet in a defined region. Furthermore, at least one component of the control system, usually at least the drive batteries database, is adapted to determine states of charge of drive batteries of these vehicles of the fleet which are located in this defined region. At least the fleet navigation system as the at least one component of the control system is also adapted to take into account traffic situations in this defined region, wherein at least the charging stations database as the at least one component of the control system is also adapted to determine and/or select automatically, depending on the particular availability of free charging stations and their respective positions in the defined region, depending on positions and states of charge of drive batteries of the vehicles of the fleet in the defined region, and depending on the respective traffic situations in the defined region, for at least one vehicle of the fleet, a charging station to carry out a charging process for the drive battery of the at least one vehicle and to propose this to the vehicle or its driver in one embodiment.

The proposed control system is designed to control an electrical charging process for a drive battery of at least one vehicle among the vehicles of the fleet. The electrical charging process is carried out with a charging station, such as a charging point, as part of the electrical charging infrastructure.

Usually at least the fleet navigation system gives consideration to all charging stations and all other vehicles of the fleet which are situated in the intended and defined region about the current position of the at least one and/or each vehicle, and the current and/or future traffic situation in this region about the at least one and/or each vehicle. Furthermore, the control system, usually at least the charging stations database, is adapted to automatically select, depending on the current and/or future traffic situation which exists or will exist between the current position of the at least one vehicle and charging stations in the region, the charging station to carry out the charging process for the drive battery of the at least one vehicle.

It is also possible for the control system to have a communication system for wireless and/or radio-based communication between the aforementioned components of the control system and the vehicles of the fleet, by which the parameters designed to carry out the process and/or corresponding information are exchanged between the components of the control system and the drive batteries or controllers and navigation assistants provided for this in the vehicles of the fleet.

In the method, a traffic load prediction is carried out for the vehicles of the fleet, taking into consideration the respective traffic situations, thereby calculating a presumable arrival time of a particular vehicle at a charging station, recognizing and/or controlling in good time any change in plan for stopping at a charging station to perform the charging process, which is also done for the occurrence of a traffic jam along the route of the particular vehicle. The method is carried out all-inclusively for all charging stations of the charging infrastructure and for all vehicles of the fleet. It is proposed that it is at first planned for each vehicle to head toward a first charging station. Moreover, for the respective or at least one vehicle the state of charge of its drive battery is predicted, taking into account the traffic or the traffic density along the route between its current position and the position of the first charging station. If the state of charge would not be sufficient to reach the first charging station, a new second charging station is ascertained for the at least one vehicle between its current position and the position of the first charging station and this is proposed for the charging process. Alternatively or additionally, a second charging station so determined can also lie on an alternative route or a detour of the vehicle to its intended destination when this second charging station has a shorter distance than the originally planned first charging station from the current position of the vehicle, while in this case such a second charging station can also lie in the opposite direction on that route where the vehicle is situated, from its current position to its intended destination. The second charging station can still be reached by the vehicle sooner than the first charging station, regardless of its position.

In the case of an autonomous vehicle, an intervention can occur automatically in the driving of the intended route through the navigation assistant of the vehicle. In the case of a manually driven vehicle, a proposal for an alternative second charging station is presented automatically to the driver of the vehicle by the navigation assistant, for example it is displayed in the navigation assistant of the vehicle and/or on a terminal device of the driver, which is located in the vehicle and exchanges information with the fleet navigation system by radio. It is possible to use a HAD controller for the navigation assistant, i.e., a controller for an autonomous or highly autonomous driving of the vehicle, and an application or app for the mobile terminal device.

The method makes possible an optimization of the workload of the charging infrastructure and a planning of charging processes for multiple vehicles of the fleet. The control system provides an all-inclusive charging infrastructure and charging participants encompassing management system for optimization of the workload and reduction of bottlenecks or overload situations of the charging infrastructure. In one possible embodiment, the method is carried out both for a first vehicle and at least one additional or second vehicle of the fleet. In the corresponding performance of one embodiment of the method, charging processes for multiple vehicles of the fleet are controlled, including planned and/or administered, with the control system, and the mentioned parameters and/or information are likewise taken into account.

The planning of the charging processes and the workload of the charging infrastructure is actively monitored, e.g., controlled with involvement of the usually dynamic parameters. In this way, the planning of a trip of the respective vehicle becomes more reliable and the charging infrastructure is optimally utilized. The central charging stations database is used here as the database for availability, such as charging capacities of charging stations, being coupled with the fleet navigation system and the drive batteries database to exchange the parameters.

The current and optionally also the predictable occupancy of the charging station is taken into account and/or planned, for example with the aid of reservations of the vehicles of the fleet. Available and/or functional or functioning charging stations and available charging capacities are taken into account and/or planned, also giving consideration to variable and/or different current strengths or voltages of the charging stations. Furthermore, plausibility checks are performed in a cycle for reserved charging stations and a “figure of merit” is assigned to designate the probability of observing of a deadline for a charging process by a particular vehicle. The mentioned different parameters are included and/or considered in this process. One parameter here is the distance of the vehicle from the charging station, taking into account the traffic situation and an estimated time of arrival (ETA) of the vehicle at the charging station, which is calculated in consideration of the parameters from the control system. With the state of charge as the parameter of the drive battery of the vehicle, a determination is made as to whether or not the charging process is timely, but also when a charging process will be necessary, for example after what distance traveled, and a corresponding future charging process will be predicted in consideration of the parameter. Moreover, the state of charge of the drive battery of the vehicle will be considered as a parameter in relation to a reserved time window (time slot) for the charging process. It is also possible to consider the current weather and temperature as meteorological parameters, besides the current and predicted traffic situation.

Furthermore, it is considered and/or predicted whether an exceeding of the charging time of a charging process of a particular vehicle at the charging station determined for this is likely and will affect the following reservations of this particular charging station for other vehicles. A check will also be made to see whether a reserved time window can be reduced or shortened if and/or because the state of charge of the drive battery of the vehicle is larger than anticipated, or at least one alternative charging station on the route of the vehicle has a smaller workload, for example.

On the basis of the parameters collected and their values and on the basis of computations of the control system, the occupancy and/or reservation planning of the charging stations is actively controlled, each time assigning a vehicle a new charging station in place of an originally scheduled charging station and/or changing an originally scheduled charging strategy, for example no full charging of the drive battery is performed, but instead only a partial charging at a first charging station, and the full charging is done at a more distant second charging station along the route. Furthermore, a server of the control system provides data for a suitable visualization to show the occupancy status of charging stations and free charging stations. It is also possible to provide a usually documented emergency unlock function for a charging cable in event of an unscheduled need for charging of another vehicle and/or a vehicle with a breakdown potential.

In another embodiment, an active management of the charging stations is implemented and/or established, including a priority handling for the particular or at least one vehicle. This is the case, for example, when time periods or time windows for charging stations become free dynamically and concentration points for vehicles in the region emerge, whereupon vehicles are invited to become partially charged in order to avoid a later stop with time loss at a concentration point of vehicles. In one embodiment, information about charging stations, such as their numbers, is relayed to the fleet navigation system. Noncritical reservations of vehicles will be rescheduled, moved and/or reserved again at other charging stations of the charging infrastructure when at least one selected, reserved and/or booked charging station has to be freed up at one position, e.g., in the case of a local excess occupancy of the charging stations, or if a vehicle has an emergency or EMERG state of charge for the drive battery.

In one embodiment, for a respective vehicle there is calculated the state of charge (SOC) of its drive battery in consideration of the surrounding traffic situation, the topography of the planned route, and optionally the length of the planned route in kilometers, and the time to travel the planned route, for example in minutes, and the resulting range of the respective vehicle. The state of charge of the drive battery is determined in dependence on the length, range and time, while the traffic situations, such as a traffic jam, can also be taken into account. Moreover, the state of charge of the drive battery is compared against the planning of the charging processes, the reservations made, and additionally, if there is no planning of the charging processes, the freely available charging stations. A check is made to see whether an intended charging station can still be reached with the vehicle, depending on the distance to be traveled and the state of charge of the drive battery. For example, a check is made to see whether energy saving modes should be initiated, and it can be considered whether the weather will allow a reduction or even a turning off of the air conditioning.

Moreover, a comfort level can be set or dictated for the vehicle for the minimum desired residual range, which level should be maintained as much as possible. For this, three energy saving modes for example are introduced additionally in an energy system of the vehicle. A first energy saving mode “MAX RNG” is set for a maximum range when the vehicle is driving, the onboard systems of the vehicle being set to reach a maximum range. A second energy saving mode “MAX ENDURANCE” is set for a maximum endurance, when the vehicle gets into a traffic jam, for example, and the onboard systems of the vehicle are set to maximum endurance. A third energy saving mode “EMERG” relates to the currently available state of charge of the drive battery of the vehicle, considering the fact that a planned charging stop and/or charging process at a charging station intended for this is no longer possible, while an alternative, closer charging station is reserved and headed for. It is possible for the drive batteries database to exchange information with the energy system and the onboard system of each vehicle of the fleet.

The energy saving modes are activated on recommendation in order to reach the originally intended charging station as the originally planned charging destination. The energy saving modes are automatically activated and the planning of the charging processes is rescheduled at a closer charging station when the originally intended or planned charging station can no longer be reached or a threshold value “comfort level for low-energy” is breached, this calculation taking into account prediction values for a traffic flow and a workload of the charging stations of the charging infrastructure. Furthermore, a forced activation of a necessary energy saving mode is done when the closest charging station can only be reached with this necessary energy saving mode. An emergency stop at a safe location, such as a parking place with no charging station, will be determined automatically for the vehicle. At the same time, a rendezvous with a mobile charging infrastructure, such as an emergency charging vehicle, can be agreed upon, coordinated and/or scheduled, and this can be relayed to the fleet navigation system. An interface of the fleet navigation system with the server for the management of the charging infrastructure or the charging stations database will be organized and/or established for this, and information will be exchanged between the fleet navigation system, the charging stations database and/or the vehicle. Moreover, information about a new charging station as the charging stop or charging destination will be relayed and/or exchanged between the fleet navigation system, the charging stations database and/or the vehicle. This also includes a relaying of information about a modified charging halt or charging stop based on priorities to the driver.

The method provides for the fleet of vehicles an overall concept for the regulated workload and/or occupancy of the electrical charging infrastructure. It makes possible a specific information exchange between vehicles as the charging participants and the charging infrastructure to optimize its workload. This reduces the uncertainty as to drivers and risks of a breakdown, since aspects such as traffic jams, delays, missed charging stations or trips not taken are considered dynamically in the method. Moreover, the time planning of a charging process and the route planning are monitored and thus controlled and/or regulated.

Of course, the features mentioned above and those yet to be explained below can be used not only in the particular indicated combination, but also in other combinations or standing alone.

### BRIEF DESCRIPTION OF THE SEVERAL VIEWS OF THE DRAWINGS

Embodiments of the invention are represented schematically with the aid of embodiments in the drawing and shall be described schematically and in detail with reference to the drawing.

FIG. 1 shows in schematic representation a charging infrastructure, several vehicles, and one embodiment of the control system according described herein for carrying out one embodiment of the method described herein.

The FIGURE are described coherently and in relation to each other. The same reference numbers are assigned to the same components.

### DETAILED DESCRIPTION

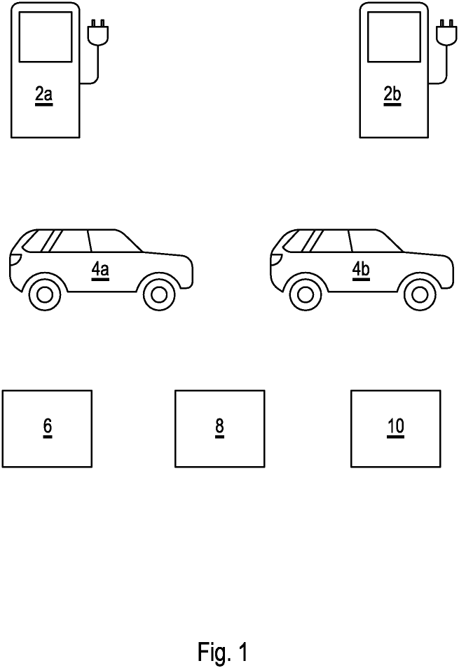

The charging infrastructure shown schematically in FIG. 1 encompasses multiple electrical charging stations 2a, 2b, which are situated at different locations or positions, of which two charging stations 2a, 2b are represented as an example. Each charging station 2a, 2b is designed to provide electrical energy to a drive battery of a vehicle 4a, 4b in a charging process and to charge it. Multiple vehicles 4a, 4b here belong to a fleet, of which only two vehicles 4a, 4b are shown here as an example.

The control system described herein comprises as its components a charging stations database 6, a drive batteries database 8 and a fleet navigation system 10, each component here being designed as a fixed server. Each component and also each charging station 2a, 2b and each vehicle 4a, 4b has a communication module of a communication system, by which the components of the control system, the charging stations 2a, 2b and the vehicles 4a, 4b in one embodiment exchange information about various parameters needing to be considered in the method, each time the communication module of a vehicle 4a, 4b being configured usually as an antenna for wireless and/or radio-based communication.

With or in the method, the charging infrastructure is monitored with and/or by the control system. The fleet navigation system 10 determines for each vehicle 4a, 4b of the fleet in a defined region at least its position and optionally also its speed and/or acceleration as kinematic parameters. The drive batteries database 8 determines for each drive battery of each vehicle 4a, 4b its state of charge and thus the quantity of electrical energy stored in it. Moreover, the fleet navigation system 10 ascertains and/or considers at least one traffic situation or traffic situations in this defined region. In the embodiment of the method, the control system automatically determines for the at least one vehicle 4a, 4b at least one charging station 2a, 2b to carry out a charging process for the drive battery of the at least one vehicle 4a, 4b, depending on the availability of at least one free charging station and its respective position in the defined region, depending on the position of at least one vehicle 4a, 4b in the region, depending on the state of charge of the drive batteries of the at least one vehicle 4a, 4b in the defined region, and depending on the respective traffic situation in the defined region.

German patent application no. 10 2022 104771.7, filed Mar. 1, 2022, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for controlling a charging infrastructure including spatially distributed electrical charging stations configured to be used by multiple vehicles of a fleet which are powered by drive batteries, the method comprising:
using a control system, wherein the control system encompasses a charging stations database, containing information about the availability of the electrical charging stations, a drive batteries database, containing information about states of charge of the drive batteries of the vehicles of the fleet, and a fleet navigation system, containing information about the spatial distribution of the vehicles of the fleet and information about respective traffic situations in which the vehicles of the fleet are involved,
determining positions of vehicles of the fleet in a defined region,
determining states of charge of drive batteries of the vehicles of the fleet in the defined region, and
based on traffic situations in the defined region, on availability of free charging stations and their respective positions in the defined region, on positions and states of charge of drive batteries of the vehicles of the fleet in the defined region, and on the respective traffic situations in the region, automatically determining, by the control system, for at least one vehicle in the defined region, a charging station to carry out a charging process for the drive battery of the at least one vehicle.

2. The method according to claim 1, wherein positions of all other vehicles of the fleet which are located in the defined region around the position of the at least one vehicle are determined, and the at least one charging station is determined based on the traffic situation existing between the position of the at least one vehicle and the at least one charging station in the defined region.

3. The method according to claim 1, wherein the at least one charging station so determined is reserved for the at least one vehicle.

4. The method according to claim 1, wherein the at least one vehicle is navigated with the fleet navigation system to the at least one proposed charging station.

5. The method according to claim 1, wherein one energy saving mode among several energy saving modes is selected and established for the at least one vehicle, and the energy saving mode is taken into account in determining the charging station to carry out the charging process for the drive battery of the at least one vehicle.

6. The method according to claim 1, wherein the control system is self-learning.

7. The method according to claim 1, wherein the duration of the charging process and the quantity of electrical energy provided to the drive battery of the at least one vehicle during the at least one charging process are taken into account in determining the charging station to carry out the charging process for the drive battery of the at least one vehicle.

8. The method according to claim 1, wherein the probability of observing a deadline for at least one charging process with the at least one determined charging station by the at least one vehicle is taken into account in determining the charging station to carry out the charging process for the drive battery of the at least one vehicle.

9. The method according to claim 1, wherein current positions of vehicles of the fleet and the current traffic situation are detected by the fleet navigation system and future positions of vehicles of the fleet and a future traffic situation are predicted by the fleet navigation system, wherein current states of charge of the drive batteries of the vehicles are ascertained by the drive batteries database and future states of charge of the drive batteries of the vehicles are predicted by the drive batteries database, and/or wherein the current availability of the charging stations is ascertained by the charging stations database and a future availability of the charging stations is predicted by the charging stations database.

10. A control system for controlling a charging infrastructure including spatially distributed electrical charging stations configured to be used by multiple vehicles of a fleet which are powered by drive batteries, the control system comprising:
a charging stations database, containing information about the availability of the electrical charging stations, a drive batteries database, containing information about states of charge of the drive batteries of the vehicles of the fleet, and
a fleet navigation system, containing information about the spatial distribution of the vehicles of the fleet and information about respective traffic situations in which the vehicles of the fleet are involved,
wherein the fleet navigation system is adapted to determine positions of vehicles of the fleet in a defined region,
wherein the drive batteries database is adapted to determine states of charge of drive batteries of the vehicles of the fleet in the defined region,
wherein the fleet navigation system is adapted to take into account traffic situations in the defined region,
wherein the charging stations database is adapted to determine automatically, depending on the availability of free charging stations and their respective positions in the defined region, depending on positions and states of charge of drive batteries of the vehicles of the fleet in the defined region, and depending on the respective traffic situations in the defined region, for at least one vehicle in the defined region, a charging station to carry out a charging process for the drive battery of the at least one vehicle.
